(19) United States
(12) Patent Application Publication
(10) Pub. No.: US 2006/0246310 A1
(43) Pub. Date: Nov. 2, 2006

(54) FLUSHABLE BODY FLUID ABSORBENT COMPOSITE

(75) Inventors: John Banks, Vancouver, British Columbia (CA); Michael Ong, North Vancouver, British Columbia (CA)

Correspondence Address: VERMETTE & CO., BOX 40, GRANVILLE SQUARE, SUITE 230 - 200 GRANVILLE STREET, VANCOUVER, BC, V6C 1S4, CA

(73) Assignee: CONSOLIDATED ECCOPROGRESS TECHNOLOGY INC., Vancouver (CA)

(21) Appl. No.: 11/306,845

(22) Filed: Jan. 12, 2006

Related U.S. Application Data
(63) Continuation-in-part of application No. 10/905,636, filed on Jan. 13, 2005.

(51) Int. Cl. B32B 29/00

(52) U.S. Cl. 428/537.5

(57) ABSTRACT

A flushable bodily liquid absorbent composite product, having a bodily liquid absorbent core and a backing layer applied to a garment side of the core. The backing layer is readily soluble in cold water and has a water impervious layer on its core side and a water resistant layer on its garment facing side.

### RELATED APPLICATION

This application is a Continuation in Part of U.S. patent application Ser. No. 10/905,636, filed on Jan. 13, 2005.

### FIELD

The present invention relates to body fluid absorbent composite products such as women's undergarments, wound dressings, breast pads, adults incontinence pouches, ostomy bags pet care products, training pads, doggy diapers and sanitary napkins.

### BACKGROUND

Disposal of plastic infant diapers, and bodily fluid absorbent products in land-fill sites is no longer a long term viable option. Often such materials constitute a biohazard risk and their disposal requires a minimum risk of human contact. Biodegrading these products first rather than allowing them to stay in their current form would be particularly beneficial to the environment.

One option that has been previously addressed in a number of patents has been the development of a composite product that can disperse in the sewerage system. Such products often rely on biodegradation of the barrier layer to disperse and, because of the time required to biodegrade, their disposal in waste water risks clogging of the sewerage system.

U.S. Pat. No. 6,217,562 issued to Brown et al. discloses a water-dispersible disposable enclosure such as an ostomy pouch which raises the temperature of the water that comes into contact with the pouch to a level at which the material melts, dissolves or otherwise disperses. This temperature elevation is accomplished by a water-activated exothermic reagent such as silica gel, aluminum chloride or calcium chloride. The water activated exothermic reagent is applied to the ostomy pouch by means of an external coating.

British Patent Application No. GB 2,295,553 discloses a bodily liquid absorbent core and a backing layer, which is applied to at least one face of the core. The backing layer is rapidly soluble in cold water but insoluble in viscous low volume bodily liquid discharges including menstrual fluid, blood and breast milk.

A layer, which is water soluble, covered by a water insoluble coating forms the backing layer, which is designed to prevent body fluids from escaping into the garment area. When the composite product is deposited in wastewater, the backing layer is exposed on its unprotected side and rapidly disperses in the water. One problem is that the backing layer is unprotected from penetration and degradation due to moisture from the garment side. Humidity at that location can be as high as 1 00 % with temperatures up to 37° C.

Accordingly, it is an object of the invention to provide a inexpensive composite product that can disperse rapidly in waste water and yet can be resistant to not only body fluids on the body side of the composite product but can also be resistant to moisture on the garment side. It is a further object to provide such a composite product, which is inexpensive.

### SUMMARY OF THE INVENTION

According to the invention there is provided a flushable bodily liquid absorbent composite product, which has a bodily liquid absorbent core, and a backing layer applied to a garment side of the core. The backing layer includes a polyvinyl dylene choride layer adjacent to the core and a paper layer adjacent to the polyvinyl dylene chloride layer coated on both sides with polyvinyl alcohol (PVOH). Adjacent to the PVOH coating on a garment side of the paper is a layer selected from the group consisting of polyvinyl acetate and shellac.

The polyvinyl alcohol may be hydrolyzed to a range of 71 to 99.4%. Preferably, it is hydrolyzed to a range of 71 to 89%.

A positioning glue may be applied to the backing layer in a pre-selected pattern having a lateral and attachment strength sufficiently high to hold said composite product together.

Preferably, the backing layer may have a layer of paper having sufficient tensile strength to resist tearing in response to ordinary body movements.

The backing layer may be paper embedded with polyvinyl alcohol.

The paper may be 12 gauge calendered paper.

The backing layer is readily soluble in cold water and has a water impervious layer on its core side and a water resistant layer on its garment facing side.

A specific pattern of positioning glue may be applied to the garment facing, backing layer where the glue has a lateral and attachment strength sufficiently high to hold the composite product together. The pattern required is a single block of approximately 45mm wide and almost as long as the product that it is to hold in place.

This same pattern of glue can be applied to so called ‘blood resistant’ or ‘moisture resistant’ polyvinyl alcohol films to eliminate the risk of positioning glue delamination. When exposed to blood or other moisture the film surface tension of these kinds of polyvinyl alcohol film changes, causing the positioning glue to separate or delaminate from the polyvinyl alcohol film and remain on the garment. Applying a pattern of positioning glue, that has good lateral strength and good adhesion to low surface tension surfaces such as polyvinyl alcohol, and is approximately 45 mm wide and approximately 65% of the length of the product (e.g. 165 mm for a 245 mm sanitary pad) eliminates this risk.

An array of super absorbent polymer coatings, such as polyacrylamide, may be used to cover the backing sheet. The coating is of sufficient thickness and density to absorb moisture on the garment side of the product and thereby lower the moisture level, while still allowing the polyvinyl alcohol film to retain its water soluble characteristics.

### BRIEF DESCRIPTION OF THE DRAWINGS

Further features and advantages will be apparent from the following detailed description, given by way of example, of a preferred embodiment taken in conjunction with the accompanying drawings, wherein:

FIG. 1 is a cross-sectional view of the composite product.

### DETAILED DESCRIPTION WITH REFERENCE TO THE DRAWINGS

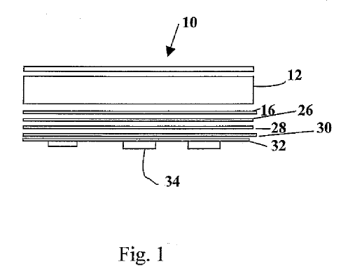

Referring to FIG. 1, the composite product 10 consists of a core 12 of absorbent material such as paper and carboxymethylcellulose. The absorbent pad of material 12 is covered by a coverstock web 14 on its body contacting side and a backing layer 22 on its garment facing side. The coverstock web 14 is made of a biodegradable material, such as rayon or viscose so that it biodegrades after disposal.

The composite product 10 utilizes paper 28 coated on both sides with polyvinyl alcohol coatings 26 and 30. In this case polyvinyl dylene chloride (PVDC) 16 is used as a coating over the garment side of the core 12. PVDC has a low transmissibility for water. The paper 28 coated on both sides with polyvinyl alcohol (PVOH) 26 and 30 is adjacent the PVDC 16. Finally, a layer of polyvinyl acetate (PVA) 32 is positioned over the PVOH coating 30 with positioning glue 34 attached to the PVA 32. A low surface tension positioning glue 34 can be applied to the polyvinyl acetate layer (PVA) 32 as a long strip of 34 inch wide and a length of about 65% of the length of the product (e.g. 165 mm or 6.5 inches in sanitary pads). The glue 34 has a high lateral strength in order to hold the composite product 10 together even if the composite product deteriorates. It is also water impervious and has high adherence strength to the PVA 32. The glue 34 adheres to the clothing of the user and helps keep the composite product in place. As the PVA 32 degrades in high humidity and high temperature environments the glue strength is preserved and through its lateral strength holds the product together as the product and glue are pulled away and removed from the consumers garment. For applications such as adult incontinence and feminine hygiene products glue may be used. However, diapers and other applications would not ordinarily use positioning glue. Ordinarily the transmission of fluid through the polyvinyl acetate equals the evaporation rate of moisture from the garment facing surface.

The time to dissolve the film 22 when dropped into a toilet of cold water is between 10 and 60 seconds.

The polyvinyl alcohol is partially hydrolyzed to a range of 71 to 89% in order to make it cold water soluble. A PVA film with a hydrolization of 98.5 to 99.4% is fully hydrolyzed. Hydrolization in the range of 71 to 99.4% would work but a lower hydrolization ensures a more rapid dissolution in water.

Polyvinyl alcohol changes size when breathing, however, paper undergoes only a small change in dimensions, even when coated with PVOH. The PVOH coating 26 on the paper 28 provides a barrier between the paper 28 and the PVDC 16, thereby preventing the PVDC 16 from flowing into the paper 28 and reducing the biodegradable properties of the paper.

The advantage of using paper 28 to replace the usual backing layer 22 is the low cost of the paper as opposed to the high cost of polyvinyl alcohol, which is normally employed. Moreover, paper has more stable mechanical properties and is less volatile. When coated with polyvinyl alcohol, paper is dimensionally stable. The paper must have sufficient strength to resist tearing when subjected to the stresses caused by movement of a user. Ordinary 12 gauge calendered paper is acceptable for this purpose as would certain synthetic papers.

Yet another alternative is the use of paper coated with polyvinyl alcohol 26 and 30 on both sides applied by means of a flexographic printer. Other methods of application may be used.

A further alternative is to add polyvinyl alcohol to the wood pulp during paper production so that the polyvinyl alcohol becomes embedded in the paper. By adding polyvinyl alcohol to the pulp during the production process the manufacture can combine the extensive drying required for both materials at the end of the production process. The inclusion of polyvinyl alcohol in the paper prevents any rustling noise that would otherwise be given off when the consumer wears the product and moves around and again lowers the cost of the film 22 used in the composite product. The polyvinyl alcohol coating also provides a barrier and gap between the paper and the polyvinyl dylene chloride preventing the polyvinyl dylene choride from flowing into the paper and making the paper less biodegradable.

Making the backing layer water resistant from the garment side slows down the rate of disintegration of the composite product somewhat, and extends the useful life of the composite product.

Accordingly, while this invention has been described with reference to illustrative embodiments, this description is not intended to be construed in a limiting sense. Various modifications of the illustrative embodiments, as well as other embodiments of the invention, will be apparent to persons skilled in the art upon reference to this description. It is therefore contemplated that the appended claims will cover any such modifications or embodiments as fall within the true scope of the invention.

What is claimed is:

1. A flushable bodily liquid absorbent composite product, comprising:
(a) a bodily liquid absorbent core; and
(b) a backing layer applied to a garment side of said core, said backing layer including:
(i) a polyvinyl dylene chloride layer adjacent to said core; and
(ii) a paper layer coated on both sides with PVOH adjacent to said polyvinyl dylene chloride layer;
(c) a layer selected from the group consisting of polyvinyl acetate and shellac.

2. The product according to claim 1, wherein said polyvinyl alcohol is hydrolyzed to a range of 71 to 99.4%.

3. The product according to claim 1, wherein said polyvinyl alcohol is hydrolyzed to a range of 71 to 89%.

4. The product according to claim 1, including a positioning glue applied to said backing layer in a pre-selected pattern having a lateral and attachment strength sufficiently high to hold said composite product together.

5. The product according to claim 1, wherein said backing layer has a layer of paper having sufficient tensile strength to resist tearing in response to ordinary body movements.

6. The product according to claim 1, wherein said backing layer is paper embedded with polyvinyl alcohol.

7. The product according to claim 1, wherein said backing layer is paper coated with polyvinyl alcohol.

8. The product according to claim 1, wherein said paper is 12 gauge calendered paper.
